(19) United States
(12) Patent Application Publication
(10) Pub. No.: US 2008/0004756 A1
(43) Pub. Date: Jan. 3, 2008

(54) Method and apparatus for display of current aircraft position and operating parameters on a graphically-imaged chart

(75) Inventor: Geoffrey S.M. Hedrick, Malvern, PA (US)

Correspondence Address: COHEN PONTANI LIEBERMAN & PAVANE LLP, Suite 1210, 551 Fifth Avenue, New York, NY, 10176, US

(73) Assignee: Innovative Solutions & Support, Inc.

(21) Appl. No.: 11/810,292

(22) Filed: Jun. 4, 2007

Related U.S. Application Data
(60) Provisional application No. 60/810,619, filed on Jun. 2, 2006.

(51) Int. Cl. G01C 23/00

(52) U.S. Cl. 701/3

(57) ABSTRACT

A method for displaying current operating parameters of an aircraft, by substantially simultaneously displaying first, second and third icons. The first icon represents the aircraft. The second icon includes a graphical crosshair having two independently positionable portions that together form a graphical crosshair positioned proximal to the first icon. The third icon on the display represents the current track or course of the aircraft, and may be formed as an arrow pointing in the direction of the current track or course, and has a length representative of the current speed of the aircraft. The three icons are preferably located within a background that may overlay other information, such as a map, on the display, and together provide greater situational awareness to the pilot by placing important information on the display in a useful format and at the portion of the display to which the pilot devotes primary attention.

The rapidly decreasing cost and availability of color flat panel displays has sparked their use in a variety of applications. Among these is the increasing presence of such displays in the cockpits of aircraft, including commercial aircraft, to display graphically simulated flight instruments that have traditionally been implemented by standalone mechanical devices. Through integration of the various functions of multiple primary flight instruments on a single flat panel display, a pilot can by viewing a single display panel monitor the most essential instrument indications needed to safely operate the aircraft.

On larger flat panels, more and more information can be included on a single display. It is also no longer uncommon to find multiple flat panels, each displaying different types of information from a variety of sources, disposed before a single pilot in an aircraft cockpit. In addition to graphical simulations of the aircraft's primary flight instruments and data representing numerous operating parameters of the aircraft, representations of real-time video images from the passenger cabin and other locations about the aircraft, weather radar and related information, GPS-derived position data, and electronically-stored navigation charts and approach plates can be presented on multi-function and/or separate flat panel displays which are located in the cockpit for ease of viewing by a pilot operating the aircraft.

The provision of GPS-based moving map displays in an aircraft cockpit is by now common in all but the oldest of aircraft. In such displays, a selectively-detailed map of an adjustably-sized region in which the aircraft is currently located is imaged on the display. In the center of the display, a small fixed or static crosshair or “t” or like representation of an aircraft denotes the current position of the aircraft within the mapped “chunk” or geographic area which is imaged on the display. When the aircraft is moving—as in flight—the portion of the map shown on the display is dynamically adjusted so that the fixed, static aircraft representation always denotes the current location of the aircraft relative to the map. Thus, the position of the aircraft representation on the display itself is fixed—typically proximate the center of the displayed map or map portion—and the map is moved to indicate the current aircraft location. The aircraft representation, as noted above, is most commonly implemented as a simple, fixed set of intersecting lines of the like.

Pilots also make extensive use of paper-based flight charts to plan and execute flights. Such charts—including enroute charts depicting, for example, low and high altitude airways, approach plates, and airport diagrams—are also now available in digitized or electronic form, and are increasingly being presented for viewing in aircraft cockpits on flat panel displays, including those mounted in the aircraft cockpit. The display of such flight charts—such, for example, as Jeppesen charts, which are widely used in both commercial and general aviation—on a cockpit-mounted flat panel display enables the pilot to readily view those charts without having to divert his or her attention to a hand-held paper chart and thereby away from the cockpit location of the various instruments and displays upon which the information and data necessary for operating the aircraft is presented. This both enhances safety in aircraft operation and decreases pilot workload.

The present invention provides functionality that further supplements the advantages of electronic display of flight chart-based information. Broadly, the invention provides for an enhanced representation of current aircraft flight position on a graphically-imaged electronic flight chart. More particularly, general GPS functionality is associated with the electronic display of chart-based information and, in addition, supplemental information on and parameters of the aircraft, its movement and its relation to the charted data is presented by way of active symbology which is utilized to represent the aircraft.

The presently preferred embodiments of the invention are discussed with reference to the appended drawings in which:

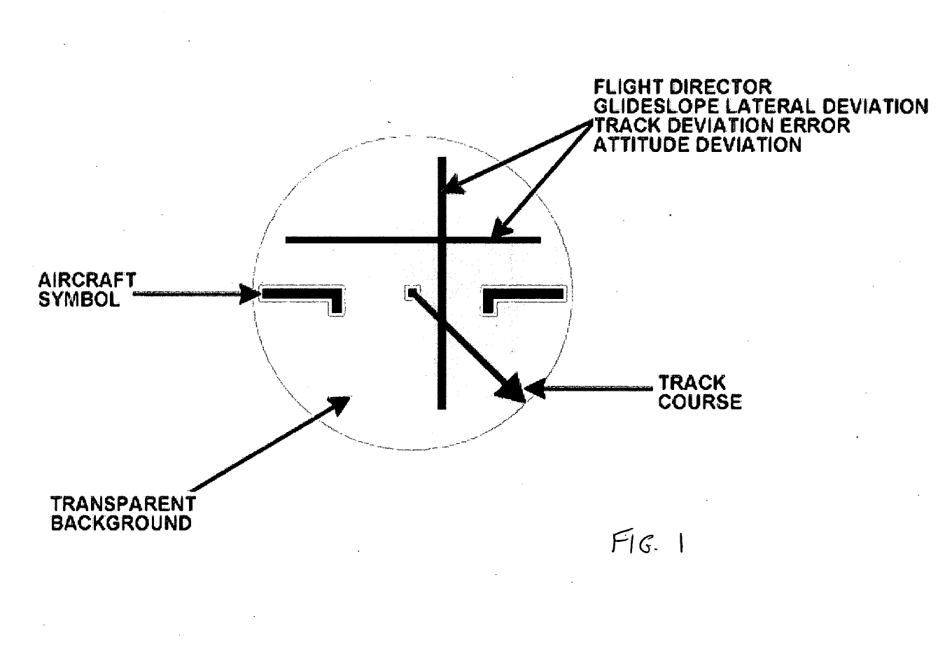

FIG. 1 is a plan view of an inventive display shown in isolation; and

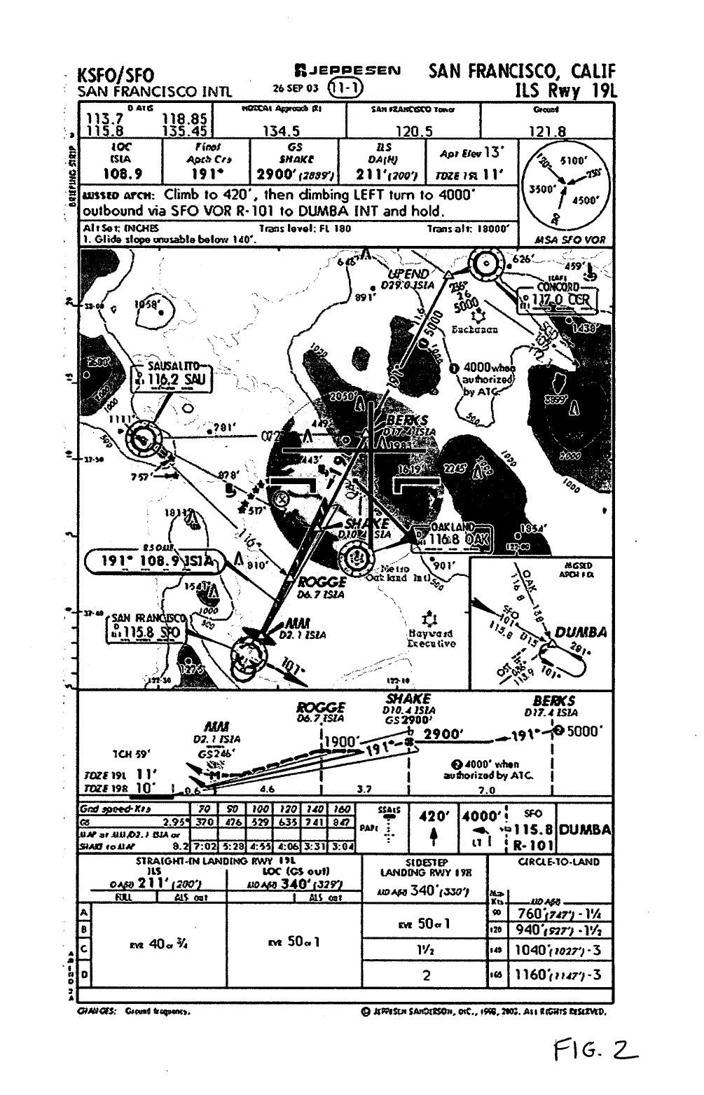

FIG. 2 is a plan view of the display of FIG. 1 overlaid on an approach plate.

In accordance with a first aspect of the invention, a representation of the aircraft is superposed or otherwise provided on or with the graphical image of the chart shown on the flat panel, preferably color flat panel, display. That is, a representation of the aircraft is presented on the display at that position of the chart-shown data which corresponds to the current location of the aircraft within the displayed chart. The location of the aircraft symbol, relative to the flat panel or frame or window in which chart or chart portion is depicted, may be fixed in the manner of a conventional GPS moving map display—as for example where the displayed chart is a relevant portion of an enroute chart—or the aircraft symbol location may dynamically move about the flat panel or frame or window relative to a fixed or static chart—as for example where the displayed chart is an approach plate, such as that shown in FIG. 2.

The use of a static crosshair or other invariable representation of the aircraft on, for example, an enroute chart carries with it a serious drawback that is well known with conventional aircraft GPS receiver displays. There is a tendency for a pilot to devote too much attention to such displays, thus operating the aircraft without sufficient attention to the other data—including the primary flight instruments—that must be utilized to safely operate the aircraft. The present invention enhances the safe operation of the aircraft by additionally providing, in an active symbology representing the aircraft, supplemental information and aircraft parameters that enhance the pilot's situational awareness during the time that attention is focused on or directed to the flat panel on which the chart is displayed.

As noted above, the symbology for representing the aircraft in superposed relation to the graphically-imaged chart is active—i.e. it dynamically changes, at least in part, to reflect changing aircraft operating parameters (in addition to aircraft location relative to the imaged chart) that it depicts. Moreover, the overall size of the symbology may and, as presently contemplated, will vary as a function of the size and/or type of the particular chart on which it is superposed, based on flight or environmental conditions necessitating more or less pilot attention thereto, optionally under the control of the flight crew, and/or as a matter of design choice. In general, and subject however to other applicable considerations, the displayed symbology will be sized appropriate to the particular chart or chart portion on which it is superposed; in FIG. 2 hereof, the symbology has been somewhat oversized for clarity of depiction and understanding.

In a currently preferred form, the symbology comprises 4 distinct elements, as shown in by way of preferred illustration in FIG. 1. The first element of the symbology, depicted as black elements surrounded by white borders, is a representation that denotes the aircraft itself. The aircraft representation is depicted in FIG. 1 as a small central square, representing the “nose” of the aircraft, and a pair of L-shaped symbols aligned with the central square and extending laterally outward therefrom, representing the “wings” of the aircraft. The aircraft “nose” is superposed on the chart at the current chart-based position of the aircraft, and may as a matter of design choice be represented in a form or by a symbol or element different from the illustrated small square; the aircraft “wings” can likewise be depicted, as a matter of design choice, in any other suitable manner. It is generally anticipated that the elements forming the aircraft symbol will generally be fixed in position relative to each other. However, although the extension of the “wings” is shown as generally horizontal in FIG. 1, the angular orientation of the wings may also, in accordance with the invention, be varied from the horizontal plane to indicate, for example, a current bank angle or orientation of the aircraft.

The second element of the preferred symbology is a crosshair, which is shown in red in FIG. 1. The crosshair is formed of a pair of intersecting lines; in FIG. 1, these are shown as a substantially horizontal line and a substantially vertical line. The two lines or bars are independently created on the display so that, in effect, they are independently “movable”, as displayed, relative to one another and relative to the aircraft symbol. In accordance with the invention, these intersecting bars can receive inputs from and/or represent, by way of example, flight director indications, glideslope and lateral deviation, altitude deviation, and/or track deviation error. They can also be angularly reoriented—i.e. from their depicted vertical/horizontal orientations—to indicate current aircraft bank. The use of these intersecting lines or bars to depict or represent still additional dynamically-varying aircraft operating and flight position and status parameters is also within the intended scope and contemplation of the invention.

The third element of the preferred symbology is an indicator of the current track or course of the aircraft. In the preferred embodiment shown in FIG. 1, the aircraft track or course is depicted by a black arrow emanating from the aircraft “nose” of the first element of the symbology, and extending in the direction of the aircraft track or course.

The fourth element of the preferred symbology is a semi-transparent or translucent circular background—shown in blue in FIG. 1—within which the first 3 elements of the symbology are encompassed or contained. The head of the arrow which depicts the aircraft track or course may define the radius or edge of the circular background. Although shown in blue in FIG. 1, the circular background can be implemented in any suitable color, or without color by merely shading the area to provide the desired lessening of transparency therethrough. The color or shading or other characteristic of this background may also be dynamically varied—for example from its normal blue to yellow or red—in response to detection of a condition requiring immediate pilot attention to thereby draw the pilot's attention thereto. In any event, as should be apparent the degree of semi-transparency or translucence, and optionally the color or shade of color, if any, is selected to maximize the desired or appropriate viewability of “background” chart features and information on which the active symbology is overlaid. Moreover, while the inclusion of such a semi-transparent or translucent circular (or otherwise appropriately shaped) background as an element of the active symbology is preferred for the purpose of more readily drawing the viewer's attention to the current location of the aircraft on or relative to the displayed chart or chart portion, this background element may be omitted as a general matter of design choice.

It is not anticipated that any specialized hardware will be required to implement the invention. In general, the functionality herein described may be implemented in software on a general purpose processor, although of course dedicated or specialized hardware may be utilized as a matter of design choice. All of the data necessary to provide the indications represented by the various elements of the symbology is already available on an aircraft, and the representations forming the active symbology as herein described can be provided by conventional graphics processors or generators as are well known in the art.

Thus, while there have shown and described and pointed out fundamental novel features of the invention as applied to a preferred embodiment thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

I claim:

1. A method of denoting, on a graphical aircraft display, current operating characteristics of the aircraft utilizing an active symbology that clearly conveys to a viewer relevant information relating to the aircraft, said method comprising the steps of:
providing, on the display, a graphical first icon delineating a nose of the aircraft;
providing, on the display, a pair of graphical second icons located on and in spaced relation to opposite sides of said first icon so as to represent wings of the aircraft, whereby said first and second icons together represent the aircraft on the display;
providing, on the display, a graphical crosshair defined by a first line and a second line that intersects said first line, said first and second lines being selectively independently positionally movable relative to each other for representing one of flight director indications, glideslope and lateral deviation indications, altitude deviation indications, track deviation indications, and course deviations, and said graphical crosshair being located in proximally overlaid relation with said first icon and said second icons; and
providing, on the display, a graphical arrow that extends outwardly from said first icon in an adjustable direction for denoting one of a current track and a current course of the aircraft.
